(19) United States
(12) Patent Application Publication
(10) Pub. No.: US 2025/0241733 A1
(43) Pub. Date: Jul. 31, 2025

(54) TIMELAPSE VISUALIZATION ON COLORED 3D MODELS

(71) Applicant: Align Technology, Inc., San Jose, CA (US)

(72) Inventors: Ran Katz, Hod Hasharon (IL); Michael Lellouch, Tel Aviv (IL); Maayan Moshe, Ramat HaSharon (IL)

(21) Appl. No.: 19/030,126

(22) Filed: Jan. 17, 2025

Related U.S. Application Data
(60) Provisional application No. 63/626,454, filed on Jan. 29, 2024.

(51) Int. Cl. A61C 9/00

(52) U.S. Cl. CPC A61C 9/0053

(57) ABSTRACT

A method comprises registering a current color-image scan to a current three-dimensional scan, registering the earlier color-image scan to an earlier three-dimensional scan, and correlating a current three-dimensional scan and the earlier three-dimensional scan to each other, such that a given area A of the current three-dimensional scan correlates to a corresponding area A′ of the earlier three-dimensional scan. Based on the correlation of the current three-dimensional scan and the earlier three-dimensional scan, the registration of the current color-image scan to the current three-dimensional scan, and the registration of the earlier color-image scan to the earlier three-dimensional scan, for the given area A of the current three-dimensional scan, the method applies (i) a portion of the earlier color-image scan registered to corresponding area A′ of the earlier three-dimensional scan to (ii) the given area A of the current three-dimensional scan.

### RELATED APPLICATIONS

This patent application claims the benefit under 35 U.S.C. § 119 (e) of U.S. Provisional Application No. 63/626,454, filed Jan. 29, 2024, which is incorporated by reference herein.

### FIELD OF THE INVENTION

The present disclosure relates generally to three-dimensional imaging, and more particularly to intraoral three-dimensional imaging.

### BACKGROUND

Digital dental impressions utilize intraoral scanning to generate three-dimensional digital models of an intraoral three-dimensional surface of a subject. Digital intraoral scanners may use structured light three-dimensional imaging using a combination of structured light projectors and cameras disposed within the intraoral scanner.

US 2019/0388193 to Saphier et al., which is assigned to the assignee of the present application and is incorporated herein by reference, describes an apparatus for intraoral scanning including an elongate handheld wand that has a probe. One or more light projectors and two or more cameras are disposed within the probe. The light projectors each have a pattern generating optical element, which may use diffraction or refraction to form a light pattern. Each camera may be configured to focus between 1 mm and 30 mm from a lens that is farthest from the camera sensor. Other applications are also described.

US 2019/0388194 to Atiya et al., which is assigned to the assignee of the present application and is incorporated herein by reference, describes a handheld wand including a probe at a distal end of the elongate handheld wand. The probe includes a light projector and a light field camera. The light projector includes a light source and a pattern generator configured to generate a light pattern. The light field camera includes a light field camera sensor. The light field camera sensor includes (a) an image sensor including an array of sensor pixels and (b) an array of micro-lenses disposed in front of the image sensor such that each micro-lens is disposed over a sub-array of the array of sensor pixels. Other applications are also described.

US 2020/0404243 to Saphier et al., which is assigned to the assignee of the present application and is incorporated herein by reference, describes a method for generating a 3D image, including driving structured light projector(s) to project a pattern of light on an intraoral 3D surface, and driving camera(s) to capture images, each image including at least a portion of the projected pattern, each one of the camera(s) comprising an array of pixels. A processor compares a series of images captured by each camera and determines which of the portions of the projected pattern can be tracked across the images. The processor constructs a three-dimensional model of the intraoral three-dimensional surface based at least in part on the comparison of the series of images. Other embodiments are also described.

PCT Publication WO 2018/152374 to Ozerov et al., which is assigned to the assignee of the present application and is incorporated herein by reference, describes processing logic which makes a comparison between first image data and second image data of a dental arch and determines a plurality of spatial differences between a first representation of the dental arch in the first image data and a second representation of the dental arch in the second image data. The processing logic determines that a first spatial difference is attributable to scanner inaccuracy and that a second spatial difference is attributable to a clinical change to the dental arch. The processing logic generates a third representation of the dental arch that is a modified version of the second representation, wherein the first spatial difference is removed in the third representation, and wherein the third representation comprises a visual enhancement that accentuates the second spatial difference. Other embodiments are also described.

U.S. Provisional Application 63/452,875 to Levy et al., which is assigned to the assignee of the present application and is incorporated herein by reference, describes techniques for selecting images from a plurality of images generated by an intraoral scanner. A method includes receiving a plurality of images of a dental site generated by an intraoral scanner, identifying a subset of images from the plurality of images that satisfy one or more selection criteria, selecting the subset of images that satisfy the one or more selection criteria, and discarding or ignoring a remainder of images of the plurality of images that are not included in the subset of images. Other embodiments are also described.

### SUMMARY OF THE INVENTION

When considering an intraoral scan of a three-dimensional intraoral surface of a subject, it may be useful to the dentist or dental technician to visually compare the colors of the three-dimensional intraoral surface to the colors of the same three-dimensional intraoral surface as captured in a scan taken at an earlier point of time, e.g., a few months earlier. Such a visual comparison may aid the dentist in determining changes in color and/or texture that have occurred on the intraoral surface. For example, the comparison may show that plaque has built up in certain areas or on certain teeth, or that a stain on a tooth has appeared, disappeared, or otherwise changed. However, simply viewing the current intraoral scan and the earlier intraoral scan side-by-side may present challenges in accurately assessing the changes. The inventors have realized that in order to aid the dentist in accurately assessing the changes in color and/or texture that have occurred in a given area of interest on the three-dimensional intraoral surface, the corresponding area of interest on the three-dimensional intraoral surface from the earlier intraoral scan can be superimposed onto the current intraoral scan such that the dentist can toggle between the visual changes that have occurred in the given area of interest within the context of the current intraoral scan. In addition, showing the patient changes that have occurred on the intraoral surface may aid in patient education, treatment acceptance, and treatment compliance.

Typically, an intraoral scan of the three-dimensional intraoral surface includes a three-dimensional scan of the three-dimensional intraoral surface as well as a color-image scan of the three-dimensional intraoral surface. The color-image scan is registered to the three-dimensional scan such that the dentist is shown a three-dimensional color model of the three-dimensional intraoral surface. For some applications, finding the corresponding area of interest on the earlier color-image scan and superimposing it onto the current three-dimensional scan in the correct position is based on a correlation that is established between the current three-dimensional scan of the three-dimensional intraoral surface and the earlier three-dimensional scan of the three-dimensional intraoral surface, each of the current and earlier three-dimensional scans being registered to their corresponding color-image scans. Thus, for some applications the current three-dimensional scan and the earlier three-dimensional scan are correlated to each other such that a given area A of the current three-dimensional scan correlates to a corresponding area A′ of the earlier three-dimensional scan. Based on the correlation of the current three-dimensional scan and the earlier three-dimensional scan, the registration of the current color-image scan to the current three-dimensional scan, and the registration of the earlier color-image scan to the earlier three-dimensional scan, for the given area A of the current three-dimensional scan, (i) a portion of the earlier color-image scan registered to corresponding area A′ of the earlier three-dimensional scan is applied to (ii) the given area A of the current three-dimensional scan.

There is therefore provided, in accordance with some applications of the present invention, a method including, using at least one computer processor (e.g., of a computing device):
obtaining a current three-dimensional scan of a three-dimensional intraoral surface;
obtaining a current color-image scan of the three-dimensional intraoral surface;
obtaining an earlier three-dimensional scan of the three-dimensional intraoral surface, taken at a point in time prior to the current three-dimensional scan;
obtaining an earlier color-image scan of the three-dimensional surface, taken at a point in time prior to the current color-image scan;
registering the current color-image scan to the current three-dimensional scan;
registering the earlier color-image scan to the earlier three-dimensional scan;
correlating the current three-dimensional scan and the earlier three-dimensional scan to each other, such that a given area A of the current three-dimensional scan correlates to a corresponding area A′ of the earlier three-dimensional scan; and
based on the correlation of the current three-dimensional scan and the earlier three-dimensional scan, the registration of the current color-image scan to the current three-dimensional scan, and the registration of the earlier color-image scan to the earlier three-dimensional scan, for the given area A of the current three-dimensional scan, applying (i) a portion of the earlier color-image scan registered to corresponding area A′ of the earlier three-dimensional scan to (ii) the given area A of the current three-dimensional scan.

For some applications:
registering the current color-image scan to the current three-dimensional scan includes correlating points u,v in the current color-image scan to respective coordinate vertices x,y,z of the current three-dimensional scan;
registering the earlier color-image scan to the earlier three-dimensional scan includes correlating points u′,v′ in the earlier color-image scan to respective coordinate vertices x′,y′,z′ of the earlier three-dimensional scan;
correlating the current three-dimensional scan and the earlier three-dimensional scan to each other includes correlating coordinate vertices x,y,z in the current three-dimensional scan to respective coordinate vertices x′,y′,z′ of the earlier three-dimensional scan; and
applying (i) a portion of the earlier color-image scan correlated to corresponding area A′ of the earlier three-dimensional scan to (ii) the given area A of the current three-dimensional scan includes, for the given area A, applying:
   (a) a set of points u′,v′ in the earlier color-image scan that are correlated to a corresponding set of respective coordinate vertices x′,y′,z′ of the earlier three-dimensional scan, the set of coordinate vertices x′,y′,z′ defining the given area A′ of the earlier three-dimensional scan, to
   (b) a set of respective coordinate vertices x,y,z of the current three-dimensional scan that are correlated to the set of respective coordinate vertices x′,y′,z′ of the earlier three-dimensional scan, the set of coordinate vertices x,y,z of the current three-dimensional scan defining the given area A of the current three-dimensional scan.

For some applications, the method further includes toggling between:
(A) applying (i) the portion of the earlier color-image scan correlated to corresponding area A′ of the earlier three-dimensional scan to (ii) the given area A of the current three-dimensional scan, and
(B) applying (i) a portion of the current color-image scan correlated to the given area A of the current three-dimensional scan to (ii) the given area A of the current three-dimensional scan.

For some applications, the method further includes, using the at least one computer processor, maintaining the application of (i) the portion of the earlier color-image scan correlated to corresponding area A′ of the earlier three-dimensional scan to (ii) the given area A of the current three-dimensional scan, while a user viewing the current three-dimensional scan manipulates a three-dimensional view of the current three-dimensional scan. The computer processor may be a processor of a computing device such as a desktop computer, a laptop computer, a server computer, and so on.

For some applications, maintaining the application of (i) the portion of the earlier color-image scan correlated to corresponding area A′ of the earlier three-dimensional scan to (ii) the given area A of the current three-dimensional scan includes maintaining the application of (i) the portion of the earlier color-image scan correlated to corresponding area A′ of the earlier three-dimensional scan to (ii) the given area A of the current three-dimensional scan while a user viewing the current three-dimensional scan rotates the three-dimensional view of the current three-dimensional scan.

For some applications, maintaining the application of (i) the portion of the earlier color-image scan correlated to corresponding area A′ of the earlier three-dimensional scan to (ii) the given area A of the current three-dimensional scan includes maintaining the application of (i) the portion of the earlier color-image scan correlated to corresponding area A′ of the earlier three-dimensional scan to (ii) the given area A of the current three-dimensional scan while a user viewing the current three-dimensional scan zooms in on or out of the three-dimensional view of the current three-dimensional scan.

For some applications, obtaining the current color-image scan includes obtaining a current color-image scan of the three-dimensional intraoral surface that was captured in the same intraoral procedure as the current three-dimensional scan was captured.

For some applications, obtaining the earlier color-image scan includes obtaining an earlier color-image scan of the three-dimensional intraoral surface that was captured in the same intraoral procedure as the earlier three-dimensional scan was captured.

For some applications, the method further includes, using the at least one computer processor, assigning a specific area of the current three-dimensional scan to be the given area A in response to a user selecting the specific area of the current three-dimensional scan.

For some applications, assigning the specific area of the current three-dimensional scan to be the given area A includes assigning a specific feature of the intraoral surface to be the given area A in response to the user selecting the specific feature.

For some applications, assigning the specific feature of the intraoral surface to be the given area A includes assigning a given tooth to be the given area A in response to the user selecting the given tooth.

For some applications, the method further includes, using the at least one computer processor, dynamically changing the given area A in response to the user moving an area-selecting indicator on a three-dimensional view of the current three-dimensional scan, such that as the user moves the area-selecting indicator, for each new given area A within the area-selecting indicator, displaying the application of (i) the portion of the earlier color-image scan correlated to corresponding area A′ of the earlier three-dimensional scan to (ii) the given area A of the current three-dimensional scan.

For some applications, the method further includes, based on the correlation of the current three-dimensional scan and the earlier three-dimensional scan, using the at least one computer processor, determining parameters of a correlation between (i) the current color-image scan of the three-dimensional intraoral surface and (ii) the earlier color-image scan of the three-dimensional intraoral surface such that points u,v in the current color-image scan correlate to respective points u′,v′ in the earlier color-image scan.

For some applications, determining parameters of the correlation includes (a) using a neural network to find features in the current color-image scan that match corresponding features in the earlier color-image scan and (b) using an optical flow algorithm on the matching features to calculate a transformation that when applied to the earlier color-image scan causes points u′,v′ in the earlier color-image scan to shift such that points u′,v′ are in the same location within the earlier color-image scan as their respective points u,v within the current color-image scan.

For some applications, determining parameters of the correlation includes (a) using a scale-invariant feature transform (SIFT) algorithm to find discrete features in the current color-image scan that match corresponding discrete features in the earlier color-image scan, (b) calculating a transformation that when applied to the discrete features in the earlier color-image scan causes the discrete features to shift such that the discrete features are in the same location within the earlier color-image scan as their matching discrete features within the current color-image scan, and (c) interpolating the transformation for areas of the earlier color-image scan between the discrete features.

For some applications, determining parameters of the correlation includes:
(a) encoding points u,v of the current color-image scan and points u′,v′ of the earlier color-image scan with a neural network, such that each of the points u,v and each of the points u′,v′ is described by a vector, the vectors of points u′,v′ in the earlier color-image scan matching the vectors of respective correlated points u,v in the current color-image scan, and
(b) for a given point u,v of the current color-image scan, using the neural network to locate the correlated point u′,v′ in the earlier color-image scan by searching for a point u′,v′ in the earlier color-image scan whose vector matches the vector of the given point u,v.

For some applications, using the neural network to locate the correlated point u′,v′ in the earlier color-image scan further includes determining a search space within the earlier color-image scan in which to search for the correlated point u′,v′ based on the correlation of the current three-dimensional scan and the earlier three-dimensional scan.

For some applications, the method further includes, using the at least one computer processor, normalizing the earlier color-image scan with respect to the current color-image scan, such that points u,v in the current color-image scan corresponding to areas of the intraoral surface that changed color between the earlier color-image scan and the current color-image scan are emphasized versus their corresponding respective points u′,v′ in the earlier color-image scan.

For some applications, normalizing the earlier color-image scan with respect to the current color-image scan includes encoding the earlier color-image scan and the current color-image with a neural network and using a Neural Style Transfer algorithm to output content of the earlier color-image scan using the style of the current color-image scan.

For some applications, normalizing the earlier color-image scan with respect to the current color-image scan includes using a Poisson Blending algorithm to output a normalized version of the earlier color-image scan in which (a) pixel values for points u′,v′ are substantially the same as pixel values of respective correlated points u,v in the current color-image scan, and (b) gradients between neighboring points u′,v′ remain substantially the same as in earlier color-image scan prior to normalization.

For some applications, the method further includes, using the at least one computer processor, analyzing the current color-image scan and the normalized earlier color-image scan and detecting an area in which there is a difference between points u,v in the current color-image scan and their corresponding respective points u′,v′ in the normalized earlier color-image scan.

For some applications, the method further includes using the at least one computer processor, based on the registration of the current color-image scan to the current three-dimensional scan, assigning a specific area of the current three-dimensional scan to be the given area A, the specific area corresponding to the area in which there is a difference between points u,v in the current color-image scan and their corresponding respective points u′,v′ in the normalized earlier color-image scan.

For some applications, the method further includes, using the at least one computer processor, visually indicating the specific area of the current three-dimensional scan to a user viewing the current three-dimensional scan.

The present invention will be more fully understood from the following detailed description of applications thereof, taken together with the drawings, in which:

### BRIEF DESCRIPTION OF THE DRAWINGS

FIG. 1 is a flowchart depicting a method of applying a portion of an earlier color-image scan of a three-dimensional intraoral surface to a current three-dimensional scan of the three-dimensional intraoral surface, in accordance with some applications of the present invention;

FIG. 2A depicts a current three-dimensional scan of a three-dimensional intraoral surface, with a current color-image scan applied to the current three-dimensional scan, in accordance with some applications of the present invention;

FIG. 2B depicts the current three-dimensional scan of FIG. 2A with a portion of an earlier color-image scan applied to the current three-dimensional scan, in accordance with some applications of the present invention;

FIGS. 3A depicts a current three-dimensional scan of a three-dimensional intraoral surface, with a current color-image scan applied to the current three-dimensional scan, in accordance with some applications of the present invention;

FIG. 3B depicts the current three-dimensional scan of FIG. 3A with a portion of an earlier color-image scan applied to the current three-dimensional scan, in accordance with some applications of the present invention;

FIGS. 4A-B depict a visualization of the encoding of points in a color-image scan by a neural network for a current color-image scan and an earlier color-image scan respectively, in accordance with some applications of the present invention; and

FIGS. 5A-D depict various viewing options of a current three-dimensional scan, in accordance with some applications of the present invention.

FIG. 6 is a block diagram illustrating a computer system, according to some embodiments.

### DETAILED DESCRIPTION

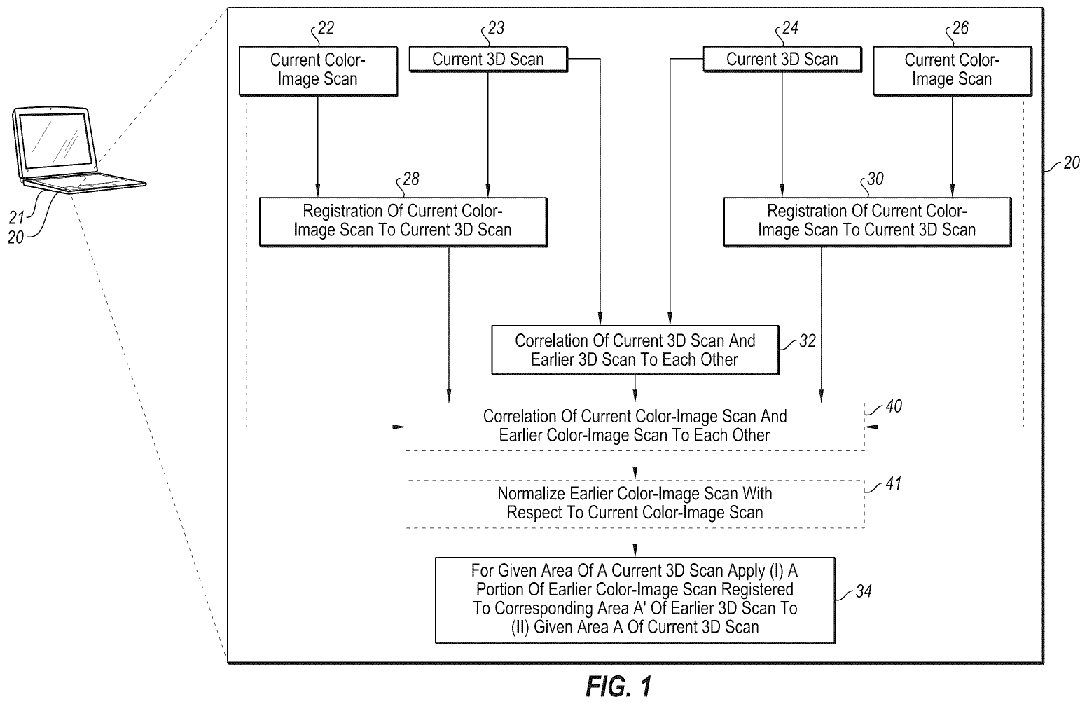

Reference is now made to FIG. 1, which is a flowchart depicting a method 20, which is performed using at least one computer processor 21 (e.g., of a computing device), of applying a portion of an earlier color-image scan of a three-dimensional intraoral surface to a current three-dimensional scan of the three-dimensional intraoral surface, in accordance with some applications of the present invention. For some applications, the method includes obtaining a current three-dimensional scan of a three-dimensional intraoral surface (step 23), and obtaining a current color-image scan of the three-dimensional intraoral surface (step 22), e.g., a current color-image scan of the three-dimensional intraoral surface that was captured in the same intraoral procedure as the current three-dimensional scan was captured. The method further includes obtaining an earlier three-dimensional scan of the three-dimensional intraoral surface (step 24), taken at a point in time prior to the current three-dimensional scan, and obtaining an earlier color-image scan of the three-dimensional surface (step 26), taken at a point in time prior to the current color-image scan, e.g., an earlier color-image scan of the three-dimensional intraoral surface that was captured in the same intraoral procedure as the earlier three-dimensional scan was captured. For example, the same patient may have had an intraoral scan (referred to herein as the earlier scan) taken at an earlier point in time, e.g., a few months prior to the current scan, and a subsequent intraoral scan (referred to herein as the current scan) taken as follow up.

Some applications are described with reference to current and earlier color-image scans, which may be two-dimensional (2D) color images or three-dimensional (3D) color images of a three-dimensional (3D) intraoral surface or a collection of 2D or 3D color images. Color-image scans may include color images generated under white light illumination, color images generated using fluorescence imaging, and/or color images generated under other lighting conditions. For example, one type of color-image scans are fluorescence imaging scans, where a current fluorescence imaging scan can be registered and compared with an earlier fluorescence imaging scan to determine differences therebetween. For fluorescence imaging, an intraoral scanner may emit light at one or more particular frequencies. The light at the one or more particular frequencies may cause illuminated teeth to fluoresce. Areas of the teeth having caries, calculus, etc. may exhibit a different fluorescence than healthy areas of teeth, for example. The fluorescence of the teeth may have different colors, which may be captured in a color image.

It should be understood that applications described with reference to color-image scans also apply to other types of 2D images, such as near infrared (NIR) 2D images, 2D images generated under specific lighting conditions, and so on. For example, some applications described with reference to color image scans also work with NIR image scans, where a current NIR image scan can be registered and compared with an earlier NIR image scan. Based on such comparison, differences in intensity and/or luminance, for example, may be determined for portions of the 3D intraoral surface between a current time and an earlier time.

For some applications, the three-dimensional scans and the color-image scans described herein may be taken using techniques described in US 2019/0388193 to Saphier et al., US 2019/0388194 to Atiya et al., and/or US 2020/0404243 to Saphier et al., each of which is assigned to the assignee of the present application and is incorporated herein by reference.

In step 28 the current color-image scan is registered to the current three-dimensional scan and in step 30 the earlier color-image scan is registered to the earlier three-dimensional scan. Typically, a three-dimensional scan results in a list of coordinate vertices corresponding to three-dimensional points in space on the three-dimensional intraoral surface, and a color-image scan results in a 2D image comprised of points u,v, e.g., pixels. For some applications, registering the current color-image scan to the current three-dimensional scan includes correlating points u,v in the current color-image scan to respective coordinate vertices x,y,z of the current three-dimensional scan. Similarly, registering the earlier color-image scan to the earlier three-dimensional scan comprises correlating points u′,v′ in the earlier color-image scan to respective coordinate vertices x′,y′,z′ of the earlier three-dimensional scan.

In step 32 the current three-dimensional scan and the earlier three-dimensional scan are correlated to each other, such that a given area A of the current three-dimensional scan correlates to a corresponding area A′ of the earlier three-dimensional scan. For some applications, the current 3D scan comprises a current virtual 3D model of the 3D intraoral surface generated based on registration and stitching together of a plurality of current 3D point cloud and the earlier 3D scan comprises an earlier virtual 3D model of the intraoral surface generated based on registration and stitching together of a plurality of earlier 3D point clouds. For some applications, the current 3D scan comprises a current 3D point cloud of the 3D intraoral surface and the earlier 3D scan comprises an earlier 3D point cloud of the intraoral surface. For some applications, correlating the current three-dimensional scan and the earlier three-dimensional scan to each other includes correlating coordinate vertices x,y,z in the current three-dimensional scan to respective coordinate vertices x′,y′,z′ of the earlier three-dimensional scan, such that the output is a list of local vertex registrations between coordinate vertices x,y, z in the current three-dimensional scan and respective coordinate vertices x′,y′, z′ in the earlier three-dimensional scan. For some applications, the correlation is interpolated in order to get a full correlation between the coordinate vertices of the current three-dimensional scan and the coordinate vertices of the earlier three-dimensional scan.

In step 34, based on the correlation of the current and earlier three-dimensional scans, the registration of the current color-image scan to the current three-dimensional scan, and the registration of the earlier color-image scan to the earlier three-dimensional scan, for the given area A of the current three-dimensional scan, the colors from the earlier color-image scan are displayed superimposed on the corresponding location of the current three-dimensional scan by applying (i) a portion of the earlier color-image scan that is registered to corresponding area A′ of the earlier three-dimensional scan to (ii) the given area A of the current three-dimensional scan. For example, given area A is defined as a set of coordinate vertices x,y,z and given area A′ is defined as the set of respective corresponding coordinate vertices x′,y′,z′ based on the correlation between the current and earlier three-dimensional scans. Thus, in step 34 (a) a set of points u′,v′ in the earlier color-image scan that are correlated (based on the registration in step 30) to the set of coordinate vertices x′,y′,z′ that define given area A′, is applied to (b) the set of coordinate vertices x,y,z of the current three-dimensional scan that define given area A.

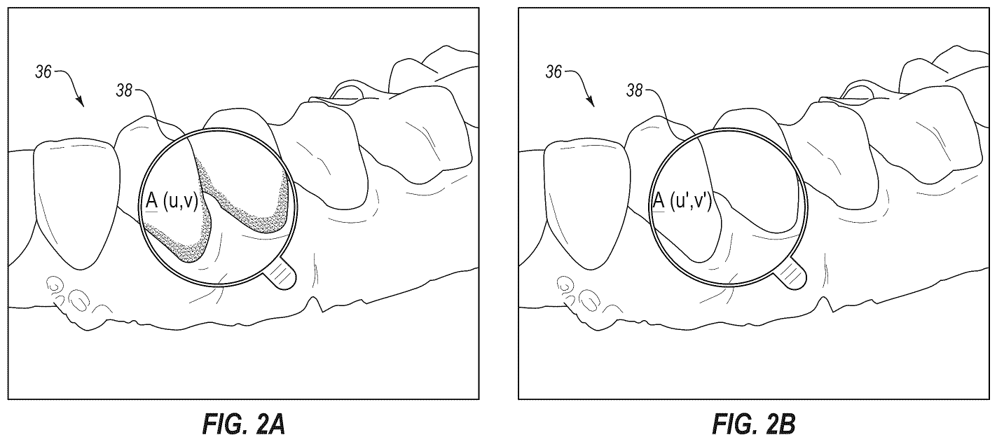

Reference is now made to FIGS. 2A-B, which depict, respectively, (a) a current three-dimensional scan 36 of a three-dimensional intraoral surface, with a current color-image scan applied to current three-dimensional scan 36, and (b) current three-dimensional scan 36 with a portion of an earlier color-image scan applied to current three-dimensional scan 36, in accordance with some applications of the present invention. In FIG. 2A, given area A of current three-dimensional scan 36 is shown with a portion of a current color-image scan correlated to given area A applied to given area A. That is, a set of points u,v in the current color-image scan that are correlated (based on the registration in step 28 of FIG. 1) to the set of coordinate vertices x,y,z that define given area A is applied to given area A.

In FIG. 2B, using step 34 of FIG. 1, a portion of an earlier color-image scan that is correlated to given area A′ of an earlier three-dimensional scan is applied to given area A of current three-dimensional scan 36. That is, a set of points u′,v′ in the earlier color-image scan that are correlated (based on the registration in step 30 of FIG. 1) to the set of coordinate vertices x′,y′,z′ that define given area A′ of the earlier three-dimensional scan is applied to given area A of current three-dimensional scan 36. The result is that the user continues to see current three-dimensional scan 36 on the screen but is shown in given area A the colors of that specific part of the three-dimensional intraoral surface as they appeared in the earlier color-image scan. As is illustrated in FIG. 2B, the colors applied to area A of current three-dimensional scan 36 differ from the colors applied to area A in FIG. 2A. In this particular example, when the colors from the earlier color-image scan are applied to given area A, the dentist or dental technician is able to see that at the time when the earlier color-image scan was taken there was no plaque in given area A, indicating that in the time since the earlier color-image scan was taken plaque has built up on the patient's teeth in that area.

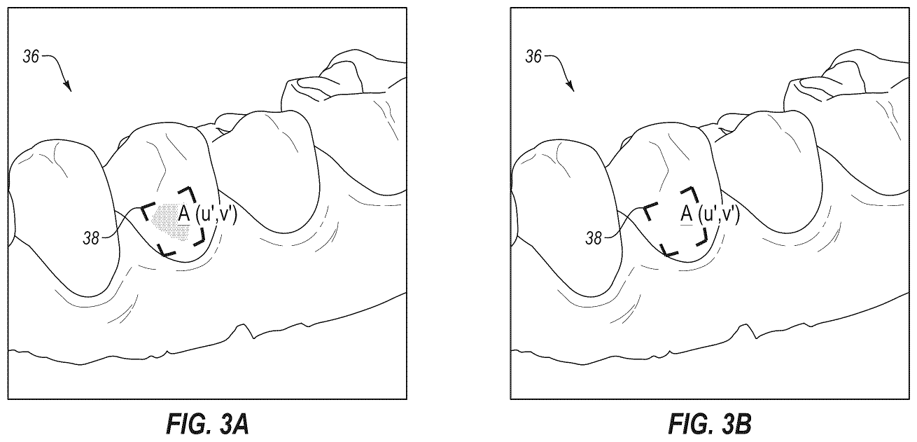

Reference is now made to FIGS. 3A-B, which depict, respectively, (a) a current three-dimensional scan 36 of a three-dimensional intraoral surface, with a current color-image scan applied to current three-dimensional scan 36, and (b) current three-dimensional scan 36 with a portion of an earlier color-image scan applied to current three-dimensional scan 36, in accordance with some applications of the present invention. FIGS. 3A-B show another example in which when the colors from the earlier color-image scan are applied to given area A, the dentist or dental technician is able to see that a stain has developed on the tooth in the time since the earlier color-image scan was taken. In FIG. 3A showing the current color-image scan applied to given area A the stain on the tooth in given area A is visible, whereas in FIG. 3B showing the portion of the earlier color-image scan applied to given area A the stain does not appear.

For some applications, step 34 further includes toggling between: (A) applying the portion of the earlier color-image scan that correlated to corresponding area A′ of the earlier three-dimensional scan to given area A of the current three-dimensional scan (i.e., what is shown, by way of example, in FIGS. 2B and 3B), and (B) applying a portion of the current color-image scan correlated to the given area A of the current three-dimensional scan to given area A of the current three-dimensional scan (i.e., what is shown, by way of example, in FIGS. 2A and 3A). The effect of this toggling is that the dentist or dental technician is able to look at a current three-dimensional scan of a three-dimensional intraoral surface of a patient and, for a given area of the three-dimensional scan, toggle just the colors of the three-dimensional intraoral surface between (i) as they were when the earlier color-image scan was taken and (ii) as they currently are. It is noted that the toggling is performed for the given area while another area of the current three-dimensional scan remains with the current color-image scan applied to it.

For some applications, step 34 further includes assigning a specific area of the current three-dimensional scan to be given area A in response to a user selecting the specific area of the current three-dimensional scan. For example, the user may mark an area of the scan with an area-selecting indicator 38, e.g., the virtual loupe shown in FIGS. 2A-B or the brackets shown in FIGS. 3A-3B. Processor 21 performs step 34 by first defining the area within the area-selecting indicator as given area A of the current three-dimensional scan.

For some applications the user may dynamically move area-selecting indicator 38 around on a three-dimensional view of current three-dimensional scan 36, and step 34 includes dynamically changing given area A in response to the user moving area-selecting indicator 38. As the user moves area-selecting indicator 38, for each new given area A within area-selecting indicator 38, processor 21 displays the application of (i) the portion of the earlier color-image scan correlated to corresponding area A′ of the earlier three-dimensional scan to (ii) the given area A of current three-dimensional scan 36. For some applications, if the user holds area-selecting indicator 38 steady in a particular area of current three-dimensional scan 36, processor 21 can toggle the color views between the earlier color-image scan and the current color-image scan for the area within the area-selecting indicator, as described hereinabove. Typically, the toggling is only performed in the area selected with area-selecting indicator 38 while another area of the current three-dimensional scan that that the user is viewing, e.g., the rest of the current three-dimensional scan, remains shown with the current color-image scan applied to it.

For some applications, processor 21 may calculate the application of the earlier color-image to the current three-dimensional scan, i.e., perform step 34, for the whole intraoral surface and subsequently displays the application of a portion of the earlier color-image scan to given area A of the current three-dimensional scan according to the user's selection of given area A with area-selecting indicator 38. Alternatively, processor 21 may calculate the application of the specific portion of earlier color-image scan corresponding to area A′ to given area A of the current three-dimensional scan in real-time in response to the user's selection of given area A with area-selecting indicator 38.

For some applications, a user may select a specific feature of the intraoral surface and processor 21 assigns the specific selected feature of the intraoral surface to be given area A in response to the user selecting the specific feature. For example, the user may select a given tooth and processor 21 assigns given area A of current three-dimensional scan 36 to be the given tooth and displays the application of the portion of the earlier color-image scan for that given tooth to the given area A of current three-dimensional scan 36.

For some applications, an advantage of the described use of a digital three-dimensional scan is that a user viewing the three-dimensional scan can manipulate a three-dimensional view of the current three-dimensional scan in order to see the intraoral surface from different viewpoints. If the user is viewing a portion of the earlier color-image scan applied to given area A of the current three-dimensional scan then it is advantageous for the colors of the older scan to remain in the correct place on the current three-dimensional scan while the user manipulates the three-dimensional view. Thus, for some applications step 34 further includes maintaining the application of (i) the portion of the earlier color-image scan correlated to corresponding area A′ of the earlier three-dimensional scan to (ii) the given area A of the current three-dimensional scan, while a user viewing the current three-dimensional scan manipulates a three-dimensional view of the current three-dimensional scan. For example, for some applications, the application of (i) the portion of the earlier color-image scan correlated to corresponding area A′ of the earlier three-dimensional scan to (ii) the given area A of the current three-dimensional scan, is maintained while a user viewing the current three-dimensional scan (a) rotates the three-dimensional view of the current three-dimensional scan, and/or (b) zooms in on or out of the three-dimensional view of the current three-dimensional scan.

Reference is now again made to FIG. 1. It may be the case that differences between the current set of scans (three-dimensional and color-image) and the earlier set of scans (three-dimensional and color-image) may cause challenges in applying a portion of the earlier color-image scan to the current three-dimensional scan. For example, if the earlier and current color-image scans were taken with different levels of light exposure then the viewer may see changes in color that are not actually due to changes that occurred on the intraoral surface, or if the teeth have moved between the earlier set of scans and the current set of scans it may be challenging to correctly apply the colors from the earlier scan to the correct tooth in the current three-dimensional scan. The inventors have realized that finding a correlation between the two color-image scans enables an accurate application of the portion of the earlier color-image scan to given area A of the current three-dimensional scan. Thus, for some applications, the method of FIG. 1 further includes an additional step 40 in which, based on the correlation of the current three-dimensional scan and the earlier three-dimensional scan (step 32), processor 21 determines parameters of a correlation between (i) the current color-image scan of the three-dimensional intraoral surface and (ii) the earlier color-image scan of the three-dimensional intraoral surface such that points u,v in the current color-image scan correlate to respective points u′,v′ in the earlier color-image scan.

For some applications, determining parameters of the correlation between the earlier color-image scan and the current color-image scan may include (a) using a neural network to find features (e.g., points u,v) in the current color-image scan that match corresponding features (e.g., points u′,v′) in the earlier color-image scan and (b) using an optical flow algorithm, e.g., the Horn-Schunck method, on the matching features to calculate a transformation that when applied to the earlier color-image scan causes points u′,v′ in the earlier color-image scan to shift such that points u′,v′ are in the same location within the earlier color-image scan as their respective points u,v are within the current color-image scan. This enables processor 21 to determine if parts of the earlier color-image scan are shifted with respect to corresponding parts of the current color-image scan. For example, if a patient's tooth has shifted between the earlier set of scans and the current set of scans, then points u′,v′ in the earlier color-image scan that are identified as points on that tooth will be in a different location within the earlier color-image scan than corresponding points u,v that are identified as points on that same tooth in the current color-image scan.

Alternatively or additionally, for some applications, determining parameters of the correlation between the earlier color-image scan and the current color-image scan may be done by finding discrete features, e.g., discrete features of the intraoral surface, in the two color-image scans that match. For example, a scale-invariant feature transform (SIFT) algorithm may be used to find discrete features in the current color-image scan that match corresponding discrete features in the earlier color-image scan. Using the matching discrete features, a transformation is calculated that when applied to the discrete features in the earlier color-image scan causes the discrete features to shift such that the discrete features are in the same location within the earlier color-image scan as their matching discrete features are within the current color-image scan. This transformation may aid in applying the portion of the earlier color-image scan to the current three-dimensional scan for a tooth that has shifted between the earlier set of scans and the current set of scans. For some applications, the transformation is interpolated for areas of the earlier color-image scan between the discrete features, for example using RBF interpolation or B-spline interpolation.

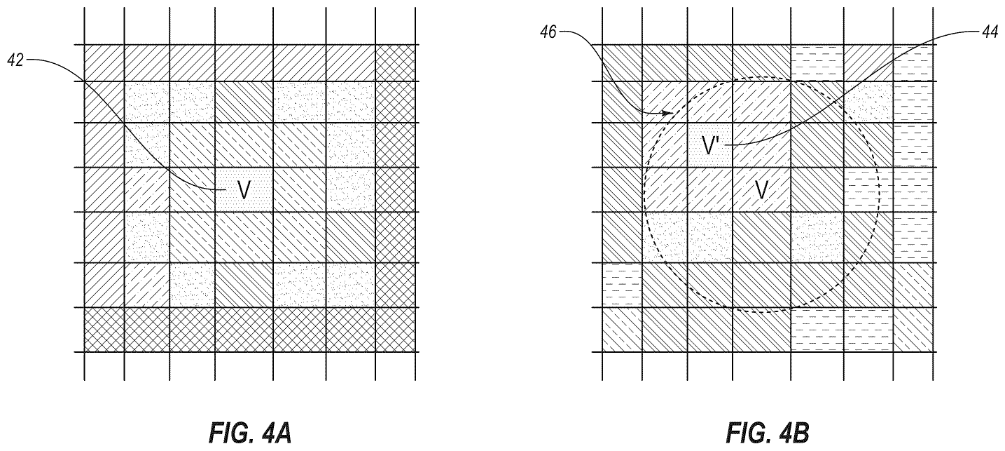

Reference is additionally made to FIGS. 4A-B, which depict a visualization of the encoding of points in a color-image scan by a neural network for a current color-image scan and an earlier color-image scan respectively, in accordance with some applications of the present invention. For some applications, determining parameters of the correlation between the earlier color-image scan and the current color-image scan may be done by registering the earlier color-image scan to the current color-image scan using a neural network. Thus, for some applications, step 40 includes (a) encoding points u,v of the current color-image scan and points u′,v′ of the earlier color-image scan with a neural network, such that each of the points u,v and each of the points u′,v′ is described by a vector.

In FIGS. 4A-B the vectors for points u,v and points u′,v′ are represented by the different shading of the boxes, each box representing a point u,v (e.g., a pixel u,v) in FIG. 4A and a point u′,v′ in FIG. 4B. Typically, a given point u′,v′ in the earlier color-image scan and a given point u,v in the current color-image scan that correlate to each other will be encoded by the neural network with matching vectors. In the example of FIGS. 4A-B, box 42 shown with the lightest shading in FIG. 4A (representing the current color-image scan) is encoded with a vector V. Box 44 shown with the same lightest shading in FIG. 4B (representing the earlier color-image scan) is encoded with the same vector, labeled V′. The matching vectors can be used in order to find the correlated points, i.e., for a given point u,v of the current color-image scan, the neural network is used to locate the correlated point u′,v′ in the earlier color-image scan by searching for a point u′,v′ in the earlier color-image scan whose vector V′ matches the vector V of the given point u,v. In the example of FIGS. 4A-B it is shown that point u′,v′ that correlates to point u,v is shifted and does not appear in the same location within the earlier color-image scan as point u,v appears within the current color-image scan. Once the neural network finds the matching pairs of points, a transformation can be applied to the earlier color-image scan in order to shift the points u′,v′ so they can be correctly applied to the current three-dimensional scan.

For some applications, the correlation of the current three-dimensional scan to the earlier three-dimensional scan in step 32 can be used in order to obtain an initial first guess for where the neural network should search within the earlier color-image scan for the point u′,v′ having the same vector as a given point u,v in the current color-image scan. Thus, for some applications, a search space 46 (represented by the dashed circle in FIG. 4B) within the earlier color-image scan in which to search for the correlated point u′,v′ is determined based on the correlation of the current three-dimensional scan and the earlier three-dimensional scan. For example, the list of local vertex registrations output by step 32 between coordinate vertices x,y,z in the current three-dimensional scan and respective coordinate vertices x′,y′, z′ in the earlier three-dimensional scan may be used to generate a first guess for the neural network when trying to locate a correlated point u′,v′ for a given point u,v.

As described hereinabove, there may be differences in color between the earlier color-image scan and the current color-image scan that are not due to the intraoral surface having changed over time, but rather to factor(s) relating to the scanning, e.g., light exposure conditions during the color-image scan. Thus, for some applications, in order to aid the dentist or dental technician in deciphering changes that have occurred in the actual intraoral surface versus when the portion of the earlier color-image scan is applied to the current three-dimensional scan, processor 21 may normalize the earlier color-image scan with respect to the current color-image scan (step 41 in FIG. 1). Thus, points u,v in the current color-image scan corresponding to areas of the intraoral surface that have changed color between the earlier color-image scan and the current color-image scan are emphasized versus their corresponding respective points u′,v′ in the earlier color-image scan. It is noted that, for some applications, step 41 may be performed prior to step 40.

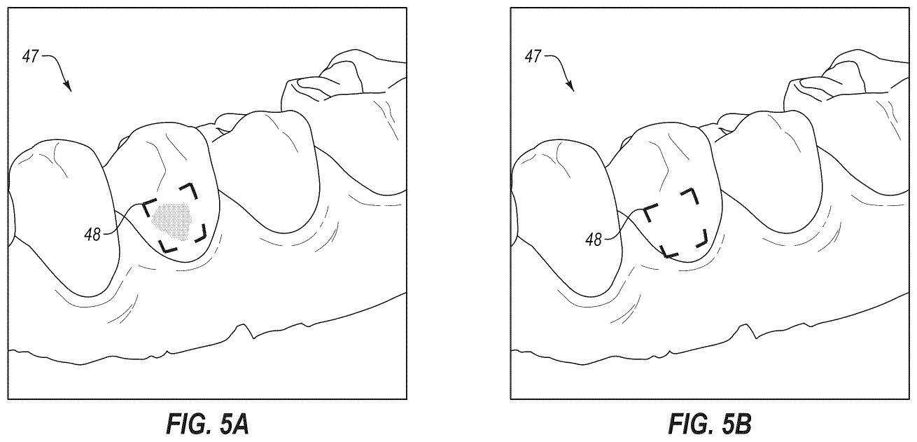

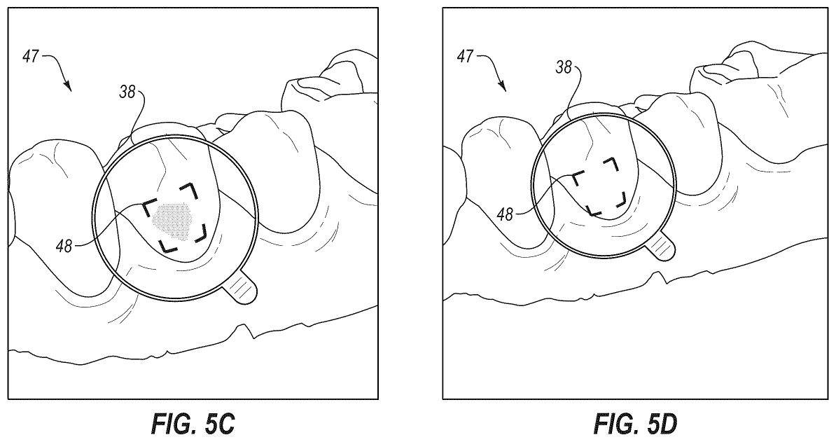

Typically, after the normalization, areas of the current color-image scan in which there was no actual change in the color of the intraoral surface appear to be the same as their corresponding areas of the earlier color-image scan. This allows a seamless transition of color between the portion of the earlier color-image scan and the current color-image scan when the portion of the earlier color-image scan is applied to the current three-dimensional scan, and enables the dentist or dental technician to more accurately identify where a change in the intraoral surface has occurred. As further described hereinbelow with respect to FIGS. 5A-C, the normalization also aids in processor 21 being able to detect the changes that have occurred in the intraoral surface by image processing.

For some applications, normalizing the earlier color-image scan with respect to the current color-image scan may be done by encoding the earlier color-image scan and the current color-image with a neural network and using a Neural Style Transfer algorithm to output the content of the earlier color-image scan using the style of the current color-image scan.

Alternatively or additionally, for some applications, normalizing the earlier color-image scan with respect to the current color-image scan may be done using a Poisson Blending algorithm to output a normalized version of the earlier color-image scan in which (a) pixel values for points u′,v′ are substantially the same as pixel values of respective correlated points u,v in the current color-image scan, and (b) gradients between neighboring points u′,v′ remain substantially the same as in earlier color-image scan prior to normalization. That is, the features of the image in the earlier color-image scan will remain the same but will be shown using the color-palette of the current color-image scan. For some applications, the following equation may be used by processor 21 for the Poisson Blending:

$$L = \int \int f * ( ∖ phi - ∖ psi\_ 0 ) + ∖ grad ( ∖ phi - ∖ psi\_ 1 )$$

where f is a weight function, e.g., a Gaussian function, \phi is the desired solution, \psi_0 is the source color mapping, \psi_1 is the target color mapping, and * is convolution.

Reference is now made to FIGS. 5A-D, which depict various viewing options of a current three-dimensional scan 47, in accordance with some applications of the present invention. For some applications, once the earlier color-image scan is normalized with respect to the current color-image scan, step 34 can further include processor 21 analyzing the current color-image scan and the normalized earlier color-image scan, e.g., using image processing, and detecting an area in which there is a difference between points u,v in the current color-image scan and their corresponding respective points u′,v′ in the normalized earlier color-image scan. Based on having detected differences in color between the current color-image scan and the normalized earlier color-image scan, processor 21 can determine a point of interest in which a change may have occurred on the intraoral surface.

Thus, for some applications, based on the registration of the current color-image scan to the current three-dimensional scan, processor 21 may assign a specific area of current three-dimensional scan 47 to be the given area A, the specific area corresponding to the area in which there is a difference between points u,v in the current color-image scan and their corresponding respective points u′,v′ in the normalized earlier color-image scan. For some applications, such as is illustrated in FIG. 5A, processor 21 may visually indicate the specific area of current three-dimensional scan 47 to the user as an area in which a change may have occurred on the intraoral surface by displaying an area indicator such as brackets 48 on a three-dimensional view of current three-dimensional scan 47. For some applications, such as is shown in FIG. 5B, processor 21 may automatically apply the corresponding portion of the earlier color-image scan to the specific area of current three-dimensional scan 47 and visually indicate to the user, e.g., with brackets 48, that that specific area of current three-dimensional scan 47 is showing the colors of the earlier color-image scan.

Alternatively or additionally, processor 21 may visually indicate to the user, e.g., with brackets 48, the specific area of current three-dimensional scan 47 in which a change may have occurred on the intraoral surface and the user, e.g., dentist or dental technician, can choose to move the area-selecting indicator 38 (such as described hereinabove) over the specific area indicated by brackets 48 in response to which processor 21 will apply the corresponding portion of the earlier color-image scan to the specific area of current three-dimensional scan 47.

It is noted that for some applications, the application of the portion of the earlier color-image scan to given area A of the current three-dimensional scan may be performed without the earlier color-image scan and the earlier three-dimensional scan being correlated to each other. That is, step 34 can be performed without an earlier three-dimensional scan, using, for example, a neural network (as described hereinabove) to correlate between the earlier color-image scan and the current color-image scan.

Applications of the disclosure described herein can take the form of a computer program product accessible from a computer-usable or computer-readable medium (e.g., a non-transitory computer-readable medium) providing program code for use by or in connection with a computer or any instruction execution system, such as the processing device disclosed hereinabove. For the purpose of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Typically, the computer-usable or computer readable medium is a non-transitory computer-usable or computer readable medium.

Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD. For some applications, cloud storage, and/or storage in a remote server is used.

A data processing system suitable for storing and/or executing program code will include at least one processor (e.g., processor 21 disclosed hereinabove) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. The system can read the inventive instructions on the program storage devices and follow these instructions to execute the methodology of the embodiments of the disclosure.

Network adapters may be coupled to the processor to enable the processor to become coupled to other processors or remote printers or storage devices through intervening private or public networks. Modems, cable modem and Ethernet cards are just a few of the currently available types of network adapters.

Computer program code for carrying out operations of the present disclosure may be written in any combination of one or more programming languages, including an object-oriented programming language such as Java, Smalltalk, C++, Python, or the like and conventional procedural programming languages, such as the C programming language or similar programming languages.

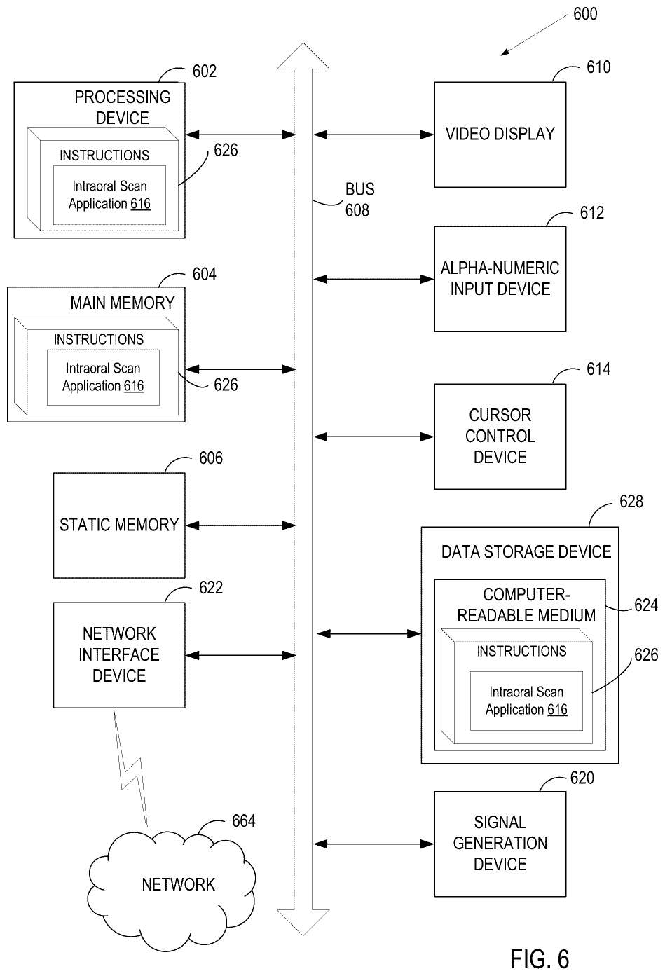

FIG. 6 illustrates a diagrammatic representation of a machine in the example form of a computing device 600 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The computing device 600 may correspond, for example, to computer processor 21 of FIG. 1. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 600 includes a processing device 602, a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a secondary memory (e.g., a data storage device 628), which communicate with each other via a bus 608.

Processing device 602 represents one or more general-purpose processors such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the processing logic (instructions 626) for performing operations and steps discussed herein.

The computing device 600 may further include a network interface device 622 for communicating with a network 664. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 628 may include a machine-readable storage medium (or more specifically a non-transitory computer-readable storage medium) 624 on which is stored one or more sets of instructions 626 embodying any one or more of the methodologies or functions described herein, such as instructions for intraoral scan application 616. A non-transitory storage medium refers to a storage medium other than a carrier wave. The instructions 626 may also reside, completely or at least partially, within the main memory 604 and/or within the processing device 602 during execution thereof by the computer device 600, the main memory 604 and the processing device 602 also constituting computer-readable storage media.

The computer-readable storage medium 624 may also be used to store intraoral scan application 626, which may perform the operations described herein above. The computer readable storage medium 624 may also store a software library containing methods for the intraoral scan application 626. While the computer-readable storage medium 624 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium other than a carrier wave that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

It will be understood that the methods described herein can be implemented by computer program instructions. These computer program instructions may be provided to a processor of a general-purpose computer, special purpose computer, or other programmable data processing apparatus to produce a machine, such that the instructions, which execute via the processor of the computer (e.g., processor 21 disclosed hereinabove) or other programmable data processing apparatus, create means for implementing the functions/acts specified in the methods described in the present application. These computer program instructions may also be stored in a computer-readable medium (e.g., a non-transitory computer-readable medium) that can direct a computer or other programmable data processing apparatus to function in a particular manner, such that the instructions stored in the computer-readable medium produce an article of manufacture including instruction means which implement the function/act specified in the methods described in the present application. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the methods described in the present application.

The processing device disclosed hereinabove is typically a hardware device programmed with computer program instructions to produce a special purpose computer. For example, when programmed to perform the methods described herein, the processing device typically acts as a special purpose processing device. Typically, the operations described herein that are performed by computer processors transform the physical state of a memory, which is a real physical article, to have a different magnetic polarity, electrical charge, or the like depending on the technology of the memory that is used.

It is noted that techniques described herein may be used in combination with techniques described in US 2019/0388193 to Saphier et al., published Dec. 26, 2019, in US 2019/0388194 to Atiya et al., published Dec. 26, 2019, in US 2020/0404243 to Saphier et al., published Dec. 4, 2020, in PCT Publication WO 2018/152374 to Ozerov et al., published Aug. 23, 2018, and in U.S. application Ser. No. 18/605,783 to Levy et al., filed Mar. 14, 2024, each of which is incorporated by reference herein.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. An intraoral scanning system, comprising:
an intraoral scanner configured to:
capture a current three-dimensional scan of a three-dimensional intraoral surface; and
capture a current color-image scan of the three-dimensional intraoral surface; and
a computing device configured to:
obtain an earlier three-dimensional scan of the three-dimensional intraoral surface, taken at a point in time prior to the current three-dimensional scan;
obtain an earlier color-image scan of the three-dimensional intraoral surface, taken at a point in time prior to the current color-image scan;
register the current color-image scan to the current three-dimensional scan;
register the earlier color-image scan to the earlier three-dimensional scan;
correlate the current three-dimensional scan and the earlier three-dimensional scan to each other, such that a given area A of the current three-dimensional scan correlates to a corresponding area A′ of the earlier three-dimensional scan; and
based on the correlation of the current three-dimensional scan and the earlier three-dimensional scan, the registration of the current color-image scan to the current three-dimensional scan, and the registration of the earlier color-image scan to the earlier three-dimensional scan, for the given area A of the current three-dimensional scan, apply (i) a portion of the earlier color-image scan registered to corresponding area A′ of the earlier three-dimensional scan to (ii) the given area A of the current three-dimensional scan.

2. The intraoral scanning system according to claim 1, wherein:
registering the current color-image scan to the current three-dimensional scan comprises correlating points u,v in the current color-image scan to respective coordinate vertices x,y, z of the current three-dimensional scan;
registering the earlier color-image scan to the earlier three-dimensional scan comprises correlating points u′,v′ in the earlier color-image scan to respective coordinate vertices x′,y′,z′ of the earlier three-dimensional scan;
correlating the current three-dimensional scan and the earlier three-dimensional scan to each other comprises correlating coordinate vertices x,y,z in the current three-dimensional scan to respective coordinate vertices x′,y′,z′ of the earlier three-dimensional scan; and
applying (i) a portion of the earlier color-image scan correlated to corresponding area A′ of the earlier three-dimensional scan to (ii) the given area A of the current three-dimensional scan comprises, for the given area A, applying:
(a) a set of points u′,v′ in the earlier color-image scan that are correlated to a corresponding set of respective coordinate vertices x′,y′, z′ of the earlier three-dimensional scan, the set of coordinate vertices x′,y′,z′ defining the area A′ of the earlier three-dimensional scan, to
(b) a set of respective coordinate vertices x,y,z of the current three-dimensional scan that are correlated to the set of respective coordinate vertices x′,y′,z′ of the earlier three-dimensional scan, the set of coordinate vertices x,y,z of the current three-dimensional scan defining the given area A of the current three-dimensional scan.

3. The intraoral scanning system according to claim 1, wherein the computing device is configured to toggle between:
(A) applying (i) the portion of the earlier color-image scan correlated to corresponding area A′ of the earlier three-dimensional scan to (ii) the given area A of the current three-dimensional scan, and
(B) applying (i) a portion of the current color-image scan correlated to the given area A of the current three-dimensional scan to (ii) the given area A of the current three-dimensional scan.

4. The intraoral scanning system according to claim 1, wherein the computing device is further configured to:
maintain application of (i) the portion of the earlier color-image scan correlated to corresponding area A′ of the earlier three-dimensional scan to (ii) the given area A of the current three-dimensional scan, while a user viewing the current three-dimensional scan manipulates a three-dimensional view of the current three-dimensional scan.

5. The intraoral scanning system according to claim 4, wherein maintaining the application of (i) the portion of the earlier color-image scan correlated to corresponding area A′ of the earlier three-dimensional scan to (ii) the given area A of the current three-dimensional scan comprises maintaining the application of (i) the portion of the earlier color-image scan correlated to corresponding area A′ of the earlier three-dimensional scan to (ii) the given area A of the current three-dimensional scan while a user viewing the current three-dimensional scan rotates the three-dimensional view of the current three-dimensional scan.

6. The intraoral scanning system according to claim 4, wherein maintaining the application of (i) the portion of the earlier color-image scan correlated to corresponding area A′ of the earlier three-dimensional scan to (ii) the given area A of the current three-dimensional scan comprises maintaining the application of (i) the portion of the earlier color-image scan correlated to corresponding area A′ of the earlier three-dimensional scan to (ii) the given area A of the current three-dimensional scan while a user viewing the current three-dimensional scan zooms in on or out of the three-dimensional view of the current three-dimensional scan.

7. The intraoral scanning system according to claim 1, wherein obtaining the current color-image scan comprises obtaining a current color-image scan of the three-dimensional intraoral surface that was captured in the same intraoral procedure as the current three-dimensional scan was captured.

8. The intraoral scanning system according to claim 1, wherein obtaining the earlier color-image scan comprises obtaining an earlier color-image scan of the three-dimensional intraoral surface that was captured in the same intraoral procedure as the earlier three-dimensional scan was captured.

9. The intraoral scanning system according to claim 1, wherein computing device is further configured to:
assign a specific area of the current three-dimensional scan to be the given area A in response to a user selecting the specific area of the current three-dimensional scan.

10. The intraoral scanning system according to claim 9, wherein assigning the specific area of the current three-dimensional scan to be the given area A comprises assigning a specific feature of the three-dimensional intraoral surface to be the given area A in response to the user selecting the specific feature.

11. The intraoral scanning system according to claim 10, wherein assigning the specific feature of the three-dimensional intraoral surface to be the given area A comprises assigning a given tooth to be the given area A in response to the user selecting the given tooth.

12. The intraoral scanning system according to claim 9, wherein computing device is further configured to:
dynamically change the given area A in response to the user moving an area-selecting indicator on a three-dimensional view of the current three-dimensional scan, such that as the user moves the area-selecting indicator, for each new given area A within the area-selecting indicator, application of (i) the portion of the earlier color-image scan correlated to corresponding area A′ of the earlier three-dimensional scan to (ii) the given area A of the current three-dimensional scan is displayed.

13. The intraoral scanning system according to claim 1, wherein computing device is further configured to:
based on the correlation of the current three-dimensional scan and the earlier three-dimensional scan, determine parameters of a correlation between (i) the current color-image scan of the three-dimensional intraoral surface and (ii) the earlier color-image scan of the three-dimensional intraoral surface such that points u,v in the current color-image scan correlate to respective points u′,v′ in the earlier color-image scan.

14. The intraoral scanning system according to claim 13, wherein determining parameters of the correlation comprises (a) using a neural network to find features in the current color-image scan that match corresponding features in the earlier color-image scan and (b) using an optical flow algorithm on the matching features to calculate a transformation that when applied to the earlier color-image scan causes points u′,v′ in the earlier color-image scan to shift such that points u′,v′ are in the same location within the earlier color-image scan as their respective points u,v within the current color-image scan.

15. The intraoral scanning system according to claim 13, wherein determining parameters of the correlation comprises (a) using a scale-invariant feature transform (SIFT) algorithm to find discrete features in the current color-image scan that match corresponding discrete features in the earlier color-image scan, (b) calculating a transformation that when applied to the discrete features in the earlier color-image scan causes the discrete features to shift such that the discrete features are in the same location within the earlier color-image scan as their matching discrete features within the current color-image scan, and (c) interpolating the transformation for areas of the earlier color-image scan between the discrete features.

16. The intraoral scanning system according to claim 13, wherein determining parameters of the correlation comprises:
(a) encoding points u,v of the current color-image scan and points u′,v′ of the earlier color-image scan with a neural network, such that each of the points u,v and each of the points u′,v′ is described by a vector, the vectors of points u′,v′ in the earlier color-image scan matching the vectors of respective correlated points u,v in the current color-image scan, and
(b) for a given point u,v of the current color-image scan, using the neural network to locate the correlated point u′,v′ in the earlier color-image scan by searching for a point u′,v′ in the earlier color-image scan whose vector matches the vector of the given point u,v.

17. The intraoral scanning system according to claim 16, wherein using the neural network to locate the correlated point u′,v′ in the earlier color-image scan comprises determining a search space within the earlier color-image scan in which to search for the correlated point u′,v′ based on the correlation of the current three-dimensional scan and the earlier three-dimensional scan.

18. The intraoral scanning system according to claim 13, wherein the computing device is further configured to:
normalize the earlier color-image scan with respect to the current color-image scan, such that points u,v in the current color-image scan corresponding to areas of the three-dimensional intraoral surface that changed color between the earlier color-image scan and the current color-image scan are emphasized versus their corresponding respective points u′,v′ in the earlier color-image scan.

19. The intraoral scanning system according to claim 18, wherein normalizing the earlier color-image scan with respect to the current color-image scan comprises encoding the earlier color-image scan and the current color-image with a neural network and using a Neural Style Transfer algorithm to output content of the earlier color-image scan using the style of the current color-image scan.

20. The intraoral scanning system according to claim 18, wherein normalizing the earlier color-image scan with respect to the current color-image scan comprises using a Poisson Blending algorithm to output a normalized version of the earlier color-image scan in which (a) pixel values for points u′,v′ are substantially the same as pixel values of respective correlated points u,v in the current color-image scan, and (b) gradients between neighboring points u′,v′ remain substantially the same as in earlier color-image scan prior to normalization.

21. The intraoral scanning system according to claim 18, wherein the computing device is further configured to:
analyze the current color-image scan and the normalized earlier color-image scan and detecting an area in which there is a difference between points u,v in the current color-image scan and their corresponding respective points u′,v′ in the normalized earlier color-image scan.

22. The intraoral scanning system according to claim 21, wherein the computing device is further configured to:
based on the registration of the current color-image scan to the current three-dimensional scan, assign a specific area of the current three-dimensional scan to be the given area A, the specific area corresponding to the area in which there is a difference between points u,v in the current color-image scan and their corresponding respective points u′,v′ in the normalized earlier color-image scan.

23. The intraoral scanning system according to claim 22, wherein the computing device is further configured to:
visually indicate the specific area of the current three-dimensional scan to a user viewing the current three-dimensional scan.

24. A system, comprising:
a computing device comprising a memory and a processor, the computing device configured to:
obtain a current three-dimensional (3D) scan of a 3D intraoral surface, a current two-dimensional (2D) scan of the 3D intraoral surface, an earlier 3D scan of the 3D intraoral surface, taken at a point in time prior to the current three-dimensional scan, and an earlier 2D scan of the 3D intraoral surface, taken at a point in time prior to the current 2D scan;
register the current 2D scan to the current 3D scan;
register the earlier 2D scan to the earlier 3D scan;
correlate the current 3D scan and the earlier 3D scan to each other, such that a given area A of the current 3D scan correlates to a corresponding area A′ of the earlier 3D scan; and
based on the correlation of the current 3D scan and the earlier 3D scan, the registration of the current 2D scan to the current 3D scan, and the registration of the earlier 2D scan to the earlier 3D scan, for the given area A of the current 3D scan, apply (i) a portion of the earlier 2D scan registered to corresponding area A′ of the earlier 3D scan to (ii) the given area A of the current 3D scan.

25. The system of claim 24, wherein the current two-dimensional scan comprises a current color-image scan, and wherein the earlier two-dimensional scan comprises an earlier color-image scan.

26. The system of claim 24, wherein the current two-dimensional scan comprises a current near-infrared (NIR) scan, and wherein the earlier two-dimensional scan comprises an earlier NIR scan.

27. The system of claim 24, wherein the current two-dimensional scan comprises a current fluorescence imaging scan, and wherein the earlier two-dimensional scan comprises an earlier fluorescence imaging scan.
